(19) United States
(12) Patent Application Publication
(10) Pub. No.: US 2017/0338096 A1
(43) Pub. Date: Nov. 23, 2017

(54) COAXIAL CABLE-TYPE PLASMA LAMP DEVICE

(71) Applicant: Hyoungsuk KIM, Siheung-si (KR)

(72) Inventor: Hyoungsuk KIM, Siheung-si (KR)

(21) Appl. No.: 15/535,023

(22) PCT Filed: Dec. 10, 2015
(86) PCT No.: PCT/KR2015/013533

§ 371 Date: Jun. 9, 2017

(30) Foreign Application Priority Data
Dec. 11, 2014 (KR) 10-2014-0178584

(51) Int. Cl. H01J 65/04; H01J 61/30; H01J 61/35; H01J 61/56

(52) U.S. Cl. CPC H01J 65/042; H01J 61/56; H01J 61/302; H01J 61/35

(57) ABSTRACT

The present invention relates to a coaxial cable-type plasma lamp device, which has, in a coaxial cable form, a conductor formed in a concentric line inside a discharge tube, has a transparent conductor formed outside the discharge tube, and enables light to be generated through a plasma discharge by emitting an electromagnetic wave into gas filling in the discharge tube. The coaxial cable-type plasma lamp device according to the present invention comprises: a discharge tube filled with discharge gas and in which a plasma discharge occurs through the discharge gas; an inner conductor formed by penetrating the discharge tube; an outer conductor formed by surrounding the discharge tube; a terminator for connecting, at a one-sided terminal of the discharge tube, the inner conductor and the outer conductor through a resistor; and an adaptor for fixing and supporting the inner conductor, the discharge tube, and the outer conductor on the other side of the discharge tube, and for separably connecting the inner conductor to an external coaxial cable.

### TECHNICAL FIELD

The present invention relates to a coaxial cable type plasma lamp device and, more particularly, to a coaxial cable type plasma lamp device capable of generating light due to plasma discharge by providing a conductor along a concentric line in a bulb in the form of a coaxial cable, providing a transparent conductor outside the bulb, and injecting electromagnetic waves into the bulb filled with a gas.

### BACKGROUND ART

In general, in a plasma lighting system (PLS), microwaves generated by a magnetron are transferred through a waveguide to a resonator, thereby generating a strong electric field in the resonator. Due to the electric field, plasma discharge occurs in the gas and a metal compound filled in a bulb and thus light is continuously emitted.

A light-emitting plasma lamp includes a power supply device for supplying power to a radio frequency (RF) amplifier, an RF oscillator for providing an initial signal, the RF amplifier for amplifying the signal received from the RF oscillator, using power received from the power supply device, an RF cavity for receiving the amplified RF signal to apply a strong electric field in the bulb, a heat dissipation structure for dissipating the heat generated due to thermal loss of RF energy, and the bulb located in the strongest electric field of the RF cavity to receive the RF energy and emit light due to the plasma discharge in an inert gas and a halogen compound filled therein.

As described above, the typical plasma-related lamp device generates plasma discharge using an RF oscillator and uses light generated due to plasma discharge, as a light source.

However, an RF amplifier and an RF cavity, e.g., a magnetron, expand or shrink depending on ambient temperature. In this case, the specific RF frequency and a resonance frequency of the RF cavity deform and thus luminous efficiency is reduced.

### RELATED ART DOCUMENT

### Patent Document

(Patent Document 0001) KR 10-2009-0052382 (Publication Date: May 25, 2009)

### DISCLOSURE

### Technical Problem

Therefore, the present invention has been made in view of the above problems, and it is one object of the present invention to provide a coaxial cable type plasma lamp device capable of generating light due to plasma discharge by providing a conductor along a concentric line in a bulb in the form of a coaxial cable, providing a transparent conductor outside the bulb, and injecting electromagnetic waves into a gas filled in the bulb.

### Technical Solution

In accordance with one aspect of the present invention, provided is a coaxial cable type plasma lamp device including a bulb filled with a dischargeable gas to generate plasma discharge using the gas, an inner conductor penetrating through the bulb, an outer conductor surrounding the bulb, a terminator for interconnecting the inner and outer conductors through a resistor at a side end of the bulb, and an adapter for fixing and supporting the inner conductor, the bulb, and the outer conductor, and detachably connecting a coaxial cable consisting of the inner and outer conductors, and the bulb to an external coaxial cable, at another side end of the bulb.

The inner conductor may include a protective film for surrounding the inner conductor to protect the inner conductor from ion impact due to plasma discharge.

The resistor of the terminator may have a resistance value ranging from zero to infinity.

The dischargeable gas may include an inert gas such as neon (Ne), a metal compound, and a gas or solid powder including sulfur (S) or the like.

The bulb may be made of a transparent material, a transparent material coated with a light-diffusing material, or an opaque material, and may have a certain thickness.

The protective film surrounding the inner conductor may be made of a transparent glass or ceramic material.

The outer conductor surrounding the bulb may be partially metal-coated or mirror-coated to reflect light.

The outer conductor may be made of a transparent material to surround the bulb.

The bulb may be provided in a cylindrical bar, tube, curve, or character shape having a certain length.

In accordance with another aspect of the present invention, provided is a coaxial cable type plasma lamp device including a bulb filled with a dischargeable gas to generate plasma discharge using the dischargeable gas, an inner conductor penetrating through the bulb, an outer conductor surrounding the bulb, and an adapter for fixing and supporting the inner conductor, the bulb, and the outer conductor, and detachably connecting a coaxial cable consisting of the inner and outer conductors, and the bulb to an external coaxial cable, at a side end of the bulb.

### Advantageous Effects

As apparent from the fore-going, according to the present invention, since a coaxial cable type transmission line is used as a bulb without using a conventional RF resonator, problems of existing technologies, e.g., resonance frequency deformation due to thermal expansion and shrinkage, may be prevented and thus high reliability may be maintained despite temperature variation of an ambient environment.

In addition, a coaxial cable type plasma lamp device according to the present invention may be bent into circles and various curves and thus may be applied to a variety of curved lamps such as circular fluorescent lamps and neon signs.

### DESCRIPTION OF DRAWINGS

FIG. 1 is a structural view of a coaxial cable type plasma lamp device according to an embodiment of the present invention.

FIG. 2 is a view showing that the coaxial cable type plasma lamp device according to an embodiment of the present invention is connected to an external coaxial cable through an adapter.

FIG. 3 is a view showing an example in which plasma discharge occurs when electromagnetic waves are injected from outside into the coaxial cable type plasma lamp device according to an embodiment of the present invention.

FIG. 4 is a view showing an example of an inner conductor and an outer conductor of the coaxial cable type plasma lamp device according to an embodiment of the present invention.

FIG. 5 is a view showing an example in which the inner conductor penetrates off center through the bulb according to an embodiment of the present invention.

FIG. 6 is a view showing an example in which no terminator is used in the coaxial cable type plasma lamp device according to an embodiment of the present invention.

### BEST MODE

The present invention will now be described more fully with reference to the accompanying drawings, in which embodiments of the invention are shown. It should be understood, however, that there is no intent to limit embodiments of the invention to the particular forms disclosed, but conversely, embodiments of the invention are to cover all modifications, equivalents, and alternatives falling within the spirit and scope of the invention.

In the drawings, like reference numerals denote like elements and descriptions thereof are not repeatedly provided herein.

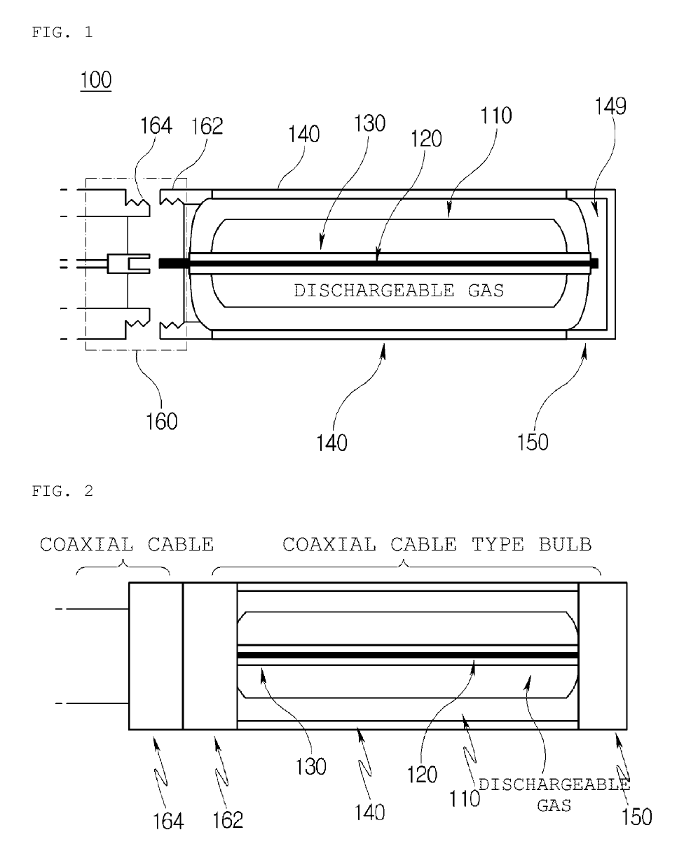

FIG. 1 is a structural view of a coaxial cable type plasma lamp device according to an embodiment of the present invention.

Referring to FIG. 1, the coaxial cable type plasma lamp device 100 according to the present invention includes a bulb 110, an inner conductor 120, a protective film 130, an outer conductor 140, a terminator 150, and an adapter 160.

The bulb 110 is filled with a dischargeable gas including an inert gas, and a metal compound. Plasma discharge occurs due to the dischargeable gas when electromagnetic waves are injected from outside into the bulb 110 through a coaxial cable. Herein, the dischargeable gas may include an inert gas such as neon (Ne), a metal compound, and a gas or solid powder including sulfur (S) or the like.

In this case, the bulb 110 is made of a transparent material having a certain thickness. The bulb 110 may be provided in a cylindrical bar, tube, curve, or character shape having a certain length.

Alternatively, the bulb 110 may be made of a transparent material coated with a light-diffusing material, or an opaque material which diffuses light. For example, in the case of an incandescent bulb, although the eyes may be dazzled by light emitted from a transparent incandescent bulb, if a translucent and milky material is used, light is diffused and thus the eyes feel comfortable.

The inner conductor 120 is provided to penetrate through the bulb 110. The inner conductor 120 generates plasma discharge in the dischargeable gas of the bulb 110 due to the electromagnetic waves injected from outside into the bulb 110 through the coaxial cable, and delivers residual electromagnetic waves to the terminator 150.

The protective film 130 is provided to surround the inner conductor 120 to protect the inner conductor 120 from ion impact due to plasma discharge. Herein, the protective film 130 is made of a transparent material such as glass or ceramic to surround the inner conductor 120.

Herein, the outer conductor 140 is made of a transparent material, e.g., a thin indium tin oxide (ITO) film, to surround the bulb 110.

The terminator 150 is connected to the inner and outer conductors 120 and 140 through a resistor 149 having a resistance value ranging from zero to infinity at a side end of the bulb 110, and has a certain impedance value.

That is, the terminator 150 serves to consume the electromagnetic waves injected from outside into the bulb 110 through the coaxial cable, using the resistor 149 having a certain resistance value. In this case, the resistor 149 may have a resistance value ranging from zero to infinity to include open and short circuits in such a manner that the electromagnetic waves of a certain part are reflected by the terminator to help sustain plasma discharge.

The adapter 160 fixes and supports the inner conductor 120, the bulb 110, and the outer conductor 140, and detachably connects the coaxial cable type plasma lamp device to an external coaxial cable, at the other side end of the bulb 110.

Herein, the adapter 160 includes an outer adapter 162 and an inner adapter 164. The outer adapter 162 for connecting the coaxial cable type plasma lamp device to the external coaxial cable is provided in the form of a female screw, and the inner adapter 164 having inserted thereinto the external coaxial cable to be connected to the inner conductor 120 is provided in the form of a male screw.

Accordingly, when the bulb 110 is connected to the external coaxial cable through the adapter 160, the outer and inner adapters 162 and 164 are combined as illustrated in FIG. 2, thereby obtaining a lamp connected to a coaxial cable. FIG. 2 is a view showing that the coaxial cable type plasma lamp device according to an embodiment of the present invention is connected to the external coaxial cable through the adapter 160.

In this case, the form of a female screw of the outer adapter 162 and the form of a male screw of the inner adapter 164 may be switched. Thus, the inner adapter 164 having the external coaxial cable inserted therein may be provided in the form of a female screw, and the outer adapter 162 to be connected to the external coaxial cable may be provided in the form of a male screw.

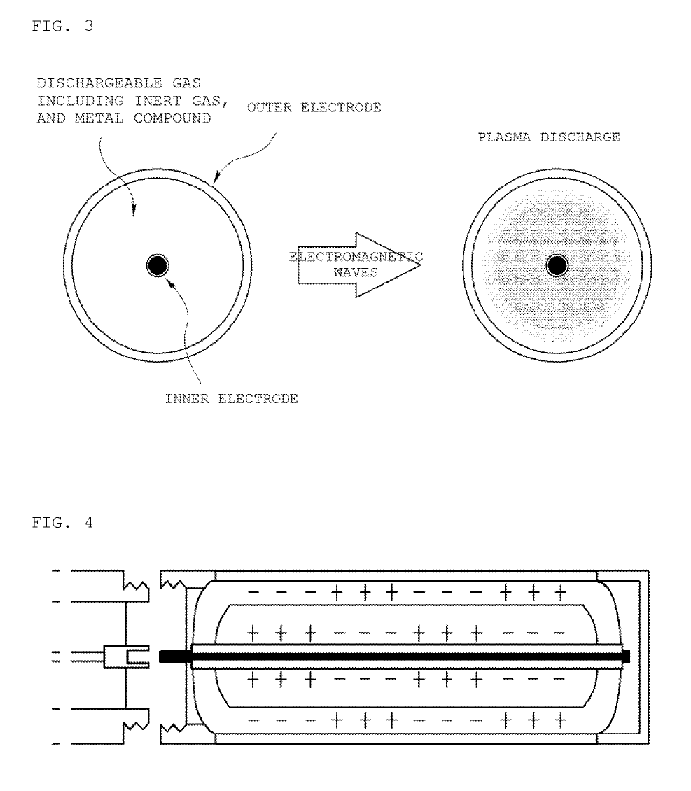

FIG. 3 is a view showing an example in which plasma discharge occurs when electromagnetic waves are injected from outside into the coaxial cable type plasma lamp device 100 according to an embodiment of the present invention.

As illustrated in FIG. 3, when the outer and inner adapters 162 and 164 are combined and thus the coaxial cable type plasma lamp device according to the present invention is connected to the external coaxial cable, electromagnetic waves are injected into the bulb 110.

In this case, as illustrated in FIG. 4, the inner and outer conductors 120 and 140 are periodically charged with plus (+) and minus (−) charges in synchronization with the frequency of the injected electromagnetic waves, respectively. At a certain moment inside the bulb 110, an electric field is generated between the inner conductor 120 charged with plus (+) charges and the outer conductor 140 charged with minus (−) charges, and the strength of the electric field is higher near the inner conductor 120 having a smaller diameter. Due to the electric field, plasma discharge occurs in the dischargeable gas filled in the bulb 110.

In addition, at a timing after a half cycle from the certain moment, an electric field is generated between the inner conductor 120 charged with minus (−) charges and the outer conductor 140 charged with plus (+) charges, and the strength of the electric field is higher near the inner conductor 120 having a smaller diameter. Due to the electric field, plasma discharge occurs in the dischargeable gas filled in the bulb 110.

FIG. 4 is a view showing an example of the inner and outer conductors and of the coaxial cable type plasma lamp device according to an embodiment of the present invention.

The coaxial cable type plasma lamp device 100 is lit by continuously emitting strong light due to plasma discharge which occurs as described above.

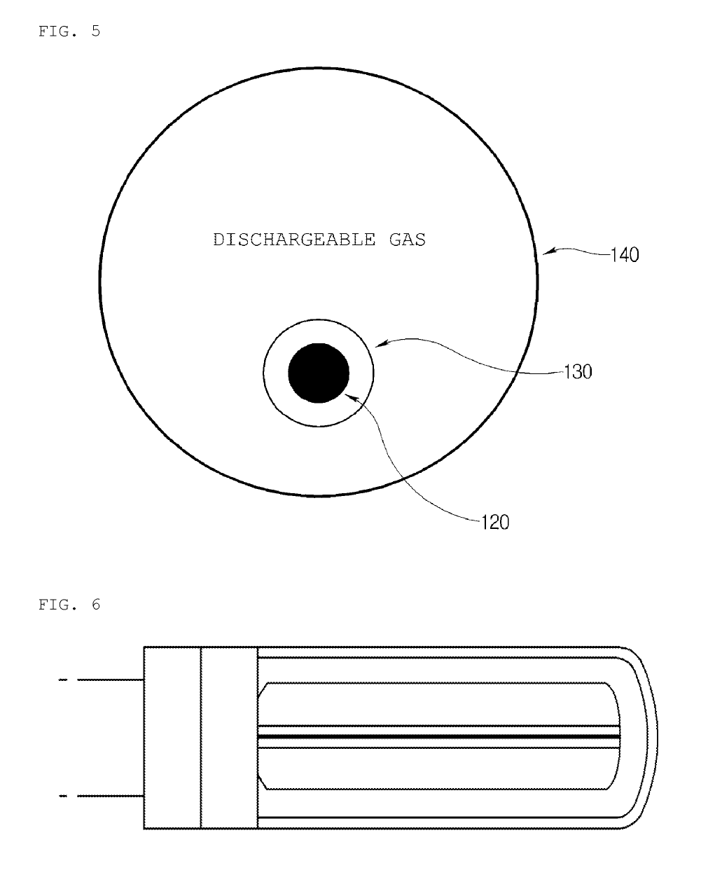

In the coaxial cable type plasma lamp device 100 according to an embodiment of the present invention, the inner conductor 120 may be located along the center of the bulb 110. Alternatively, the inner conductor 120 may not be located along the center of the bulb 110 but may penetrate off center through the bulb 110 as illustrated in FIG. 5. FIG. 5 is a view showing an example in which the inner conductor 120 penetrates off center through the bulb 110 according to an embodiment of the present invention. Since the inner conductor 120 penetrates off center through the bulb 110 as illustrated in FIG. 5, plasma discharge may easily occur.

In addition, a certain part of the outer conductor 140 may be metal-coated to have a reflective surface like a mirror and thus light generated due to plasma discharge may proceed in a certain direction. In this case, an example of metal coating includes aluminum deposition such as mirror coating.

In FIG. 1, the adapter 160 may be configured as a radio frequency (RF) coupler or as a subminiature version A (SMA)-type or N-type adapter.

In the coaxial cable type plasma lamp device 100 according to an embodiment of the present invention, the terminator 150 interconnects the inner and outer conductors 120 and 140 through the resistor 149 at a side end of the bulb 110. Alternatively, the side end of the bulb 110 may be configured to terminate the inner conductor 120 therein without using the terminator 150.

When no terminator is used in the coaxial cable type plasma lamp device 100, the inner conductor 120 may be located in the bulb 110 and surrounded by the protective film 130. In addition, the bulb 110 may be surrounded by the outer conductor 140. FIG. 6 is a view showing an example in which the inner conductor 120 is surrounded by the protective film 130 and the bulb 110 is surrounded by the outer conductor 140 when no terminator is used in the coaxial cable type plasma lamp device 100 according to an embodiment of the present invention.

As described above, according to the present invention, a coaxial cable type plasma lamp device capable of generating light due to plasma discharge by providing a conductor along a concentric line in a bulb in the form of a coaxial cable, providing a transparent conductor outside the bulb, and injecting electromagnetic waves through the coaxial cable into a gas filled in the bulb may be implemented.

While the present invention has been particularly shown and described with reference to embodiments thereof, it will be understood by one of ordinary skill in the art that various changes in form and details may be made therein without departing from the spirit and scope of the invention as defined by the following claims. The embodiments should be considered in a descriptive sense only and not for purposes of limitation. Therefore, the scope of the invention is defined not by the detailed description of the invention but by the following claims, and all differences within the scope will be construed as being included in the present invention.

### INDUSTRIAL APPLICABILITY

The present invention may be applied to a coaxial cable type plasma lamp device capable of generating light due to plasma discharge by providing a conductor in a bulb in the form of a coaxial cable, providing a transparent conductor outside the bulb, and injecting electromagnetic waves through the coaxial cable into a gas filled in the bulb.

100: Coaxial cable type plasma lamp device

110: Bulb

120: Inner conductor

130: Protective film

140: Outer conductor

149: Resistor

150: Terminator

160: Adapter

1. A coaxial cable type plasma lamp device comprising:
a bulb filled with a dischargeable gas to generate plasma discharge using the dischargeable gas;
an inner conductor penetrating through the bulb;
an outer conductor surrounding the bulb;
a terminator for interconnecting the inner and outer conductors through a resistor at a side end of the bulb; and
an adapter for fixing and supporting the inner conductor, the bulb, and the outer conductor, and detachably connecting the inner and outer conductors to an external coaxial cable, at another side end of the bulb.

2. The coaxial cable type plasma lamp device according to claim 1, wherein the inner conductor comprises a protective film for surrounding the inner conductor to protect the inner conductor from ion impact due to plasma discharge.

3. The coaxial cable type plasma lamp device according to claim 1, wherein the bulb is made of a transparent material, a transparent material coated with a light-diffusing material, or an opaque material, and has a certain thickness.

4. The coaxial cable type plasma lamp device according to claim 1, wherein the protective film is made of a transparent glass or ceramic material.

5. The coaxial cable type plasma lamp device according to claim 1, wherein the outer conductor is made of a transparent material to surround the bulb.

6. The coaxial cable type plasma lamp device according to claim 1, wherein the outer conductor surrounding the bulb is partially metal-coated or mirror-coated to reflect light.

7. The coaxial cable type plasma lamp device according to claim 1, wherein the bulb is provided in a cylindrical bar, tube, curve, or character shape having a certain length.

8. A coaxial cable type plasma lamp device comprising:
a bulb filled with a dischargeable gas to generate plasma discharge using the dischargeable gas;
an inner conductor penetrating through the bulb;
an outer conductor surrounding the bulb; and
an adapter for fixing and supporting the inner conductor, the bulb, and the outer conductor, and detachably connecting the inner and outer conductors to an external coaxial cable, at a side end of the bulb.
